(19) United States
(12) Patent Application Publication
(10) Pub. No.: US 2025/0223046 A1
(43) Pub. Date: Jul. 10, 2025

(54) ELECTRICAL ENGINE MOUNTING ARRANGEMENT

(71) Applicant: INNVOLVE CAPITAL OY, Espoo (FI)

(72) Inventors: Aki SUOKAS, Espoo (FI); Antti PÖLLÄNEN, Espoo (FI); Mika KORHONEN, Espoo (FI)

(21) Appl. No.: 18/700,330

(22) PCT Filed: Oct. 14, 2022
(86) PCT No.: PCT/FI2022/050691

§ 371 Date: Apr. 11, 2024

(30) Foreign Application Priority Data
Oct. 15, 2021 (FI) 20216065

(51) Int. Cl. B64D 27/357; B64D 27/31; B64D 27/32

(52) U.S. Cl. CPC B64D 27/357; B64D 27/31; B64D 27/32

(57) ABSTRACT

An electrical engine mounting arrangement for providing propulsion power to a vehicle includes a mounting block, an electric motor, a power transfer shaft arranged to rotate in response to the rotation of the electric motor and aligned along a rotation axis. The rotation axis lies on a division plane. One or more first side battery compartments are fixed to the mounting block at the first side of the division plane, and one or more second side battery compartments are fixed to the mounting block at the second side. The batteries housed in the battery compartments supply power to the electric motor.

### FIELD OF THE INVENTION

The present invention relates to an electrical engine mounting arrangement for providing propulsion power to a vehicle, and more particularly to an electrical engine mounting arrangement for providing propulsion power to a vehicle according to the independent claim 1.

### BACKGROUND OF THE INVENTION

In the prior art, various ways to attach an electrical engine to a vehicle for propulsion purposes are known. Energy for the propulsion in electric vehicles is provided almost always with batteries that act as energy storage units. Two basic categories of batteries exist: Fixed attachments of batteries in which the batteries are charged through an electric plug arranged into the vehicle, and detachable attachments of batteries in which the battery can be inserted and detached from the vehicle for charging. An example of a fixed attachment can be found in hybrid or electric cars. An example of a detachable arrangement is found in a light electric vehicle like an e-bike.

A detachable battery for vehicle propulsion is advantageous in many ways. Battery is a part subject to wear, tear and ageing. Replacing batteries with a fixed attachment is laboursome. With detachable batteries, the battery can be carried to an indoor charging station which makes the charging safer. Batteries are generally expensive, and it is advantageous to be able use similar or same kind of detachable batteries in various kinds of vehicles. Making batteries available as separate, detachable and removable units may drive their cost down and reliability up due to wider mass production. Detachable batteries may be stored separately from the vehicle they provide energy to. For at least two sets of batteries, one set may be in operation, providing energy to the vehicle, and the other set may be charged at the same time, and thus the charging takes no operational time from the vehicle.

One of the problems associated with the prior art is that detachably attaching the battery or batteries in a vehicle is challenging. Batteries tend to heat up when they provide electric power, with a risk of overheating and a so-called thermal runaway. It is challenging to keep the ohmic losses minimal with the prior art battery attachments. Batteries are heavy, easily causing imbalance to the center of gravity of the vehicle. This may then lead to difficulties in controlling the vehicle when the vehicle moves, for example flies or passes through the water in high speed.

### BRIEF DESCRIPTION OF THE INVENTION

An object of the present invention is to provide electrical engine mounting arrangement for providing propulsion power to a vehicle so that the prior art problems are solved or at least alleviated.

The objects of the invention are achieved by which are characterized by what is stated in the independent claim 1.

The preferred embodiments of the invention are disclosed in the dependent claims.

The invention is based on the idea of locating the battery compartments of the electrical engine mounting arrangement on two sides of a division plane such that the rotation axis of the power transfer shaft lies on the division plane. This makes it possible to shorten the electric connections to avoid ohmic losses, and to provide a balanced structure in terms of weight distribution.

As an aspect of the invention, an electrical engine mounting arrangement for providing propulsion power to a vehicle is disclosed. The electrical engine mounting arrangement comprises
A) a mounting block,
B) an electric motor fixedly attached to the mounting block,
C1) a motor shaft, the electric motor arranged to rotate the motor shaft,
C2) a power transfer shaft, the power transfer shaft arranged to rotate in response to the rotation of the motor shaft, the power transfer shaft aligned along a rotation axis such that the rotation axis lies on a division plane, the division plane arranged to split the electrical engine mounting arrangement into two portions, a first portion at a first side of the division plane, and a second portion at a second side of the division plane.

The electrical engine mounting arrangement comprises also
D) one or more first side battery compartments fixedly attached to the mounting block at the first side of the division plane, each of the first side battery compartments comprising:
   a first side battery compartment top,
   a first side battery compartment bottom,
   one or more first side battery compartment walls between the first side battery compartment top and the first side battery compartment bottom,
   the first side battery compartment top, the first side battery compartment bottom and the one or more first side battery compartment walls defining a first inner volume of the first side battery compartment, the first inner volume of the first side battery compartment arranged to house at least part of at least one first side battery such that the at least one first side battery is detachable, the at least one first side battery arranged to supply energy to the electric motor for rotating the motor shaft.

The electrical engine mounting arrangement comprises also
E) one or more second side battery compartments fixedly attached to the mounting block at the second side of the division plane, each of the second side battery compartments comprising:
   a second side battery compartment top,
   a second side battery compartment bottom,
   one or more second side battery compartment walls between the second side battery compartment top and the second side battery compartment bottom,
   the second side battery compartment top, the second side battery compartment bottom and the one or more second side battery compartment walls defining a second inner volume of the second side battery compartment, the second inner volume of the second side battery compartment arranged to house at least part of at least one second side battery such that the at least one second side battery is detachable, the at least one second side battery arranged to supply energy to the electric motor for rotating the motor shaft. Advantage of the electrical engine mounting arrangement is that it provides easy access to the batteries supplying energy for the operation of the electric motor, is well-balanced in terms of mechanics and center of gravity, and shortens the required cabling and other electrical connections, thus reducing ohmic losses and risks of electrical failures.

In an embodiment, the first side battery compartment top is located at a first distal end of the first side battery compartment.

In an embodiment, the first side battery compartment bottom is located at a first proximal end of the first side battery compartment, the first proximal end being closer to the mounting block than the first distal end.

In an embodiment, the second side battery compartment top is located at a second distal end of the second side battery compartment.

In an embodiment, the second side battery compartment bottom is located at a second proximal end of the second side battery compartment, the second proximal end being closer to the mounting block than the second distal end.

In an embodiment of the electrical engine mounting arrangement, the mounting block comprises: a first mounting block end and a second mounting block end opposite the first mounting block end; or a first mounting block end and a second mounting block end opposite the first mounting block end, and the electrical engine mounting arrangement is arranged to be attached to the vehicle at the second mounting block end. This arrangement is advantageous to enable easy access to the batteries.

In an embodiment of the electrical engine mounting arrangement:
the mounting block comprises an I-beam extending between the first mounting block end and the second mounting block end; or
the mounting block comprises an I-beam extending between the first mounting block end and the second mounting block end,
the I-beam comprises a top flange, a bottom flange and a web, and
the one or more first side battery compartments are fixedly attached to the top flange, to the bottom flange and to the web, and
the one or more second side battery compartments are fixedly attached to the top flange, to the bottom flange and to the web. An I-beam provides a very rigid and reliable construction.

In an embodiment of the electrical engine mounting arrangement,
the mounting block comprises a triangular cross section beam extending between the first mounting block end and the second mounting block end; or
the mounting block comprises a triangular cross section beam extending between the first mounting block end and the second mounting block end,
the triangular cross section beam comprises a top section split by the division plane, a first side section at the first side of the division plane, and a second side section at the second side of the division plane,
the one or more first side battery compartments are fixedly attached to the first side section, and
the one or more second side battery compartments are fixedly attached to the second side section. A beam with a triangular cross section provides also a very rigid and reliable construction.

In an embodiment of the electrical engine mounting arrangement the electrical engine mounting arrangement is attached fixedly to a tubing frame, the tubing frame comprising interjoined tubing sections, and the electrical engine mounting arrangement is attached to the vehicle with the tubing frame. A tubing frame is lightweight and rigid.

In an embodiment of the electrical engine mounting arrangement, the electrical engine mounting arrangement comprises
more than one first side battery compartments, each of the first side battery compartments separated from an adjacent first side battery compartment with a first side gap, and
more than one second side battery compartments, each of the second side battery compartments separated from an adjacent second side battery compartment with a second side gap. As an advantage, the first side gaps and second side gaps provide extra ventilation and cooling for the batteries.

In an embodiment of the electrical engine mounting arrangement, the electrical engine mounting arrangement comprises a propulsion element, the propulsion element arranged to provide propulsion to the vehicle in response to the rotation of the power transfer shaft, the electrical engine mounting arrangement being fixedly attached to the vehicle. This is one of the ways to take propulsive power out of the electrical engine mounting arrangement.

In an embodiment of the electrical engine mounting arrangement, the electrical engine mounting arrangement comprises a propulsion element attached to the power transfer shaft, the propulsion element arranged to provide propulsion to the vehicle in the direction of the power transfer shaft, the electrical engine mounting arrangement being fixedly attached to the vehicle. This is one way to take propulsive power out of the electrical engine mounting arrangement.

In an embodiment of the electrical engine mounting arrangement, the electrical engine mounting arrangement comprises a propulsion element attached to the power transfer shaft, the propulsion element arranged to provide propulsion to an aircraft in the direction of the power transfer shaft, the electrical engine mounting arrangement being fixedly attached to a nose of the aircraft. This is one way to take propulsive power out of the electrical engine mounting arrangement to a flying (airborne) vehicle like an airplane or other such aircraft.

In an embodiment of the electrical engine mounting arrangement, the electrical engine mounting arrangement comprises a propulsion element attached to the power transfer shaft, the propulsion element arranged to provide propulsion to an aircraft in the direction of the power transfer shaft, the electrical engine mounting arrangement being fixedly attached to a wing of the aircraft. This is one way to take propulsive power out of the electrical engine mounting arrangement to a flying (airborne) vehicle like an airplane or other such aircraft.

For an aircraft with two wings, two electrical engine mounting arrangements may be provided, one for each of the wings.

For an aircraft with two wings, three electrical engine mounting arrangements may be provided, one for each of the wings and one at the nose of the aircraft.

For an aircraft with two wings, four electrical engine mounting arrangements may be provided, two for each of the wings.

In an embodiment of the electrical engine mounting arrangement, the electrical engine mounting arrangement comprises a propulsion element attached to the power transfer shaft, the propulsion element arranged to provide propulsion to an aircraft in the direction of the power transfer shaft, the electrical engine mounting arrangement being fixedly attached to a nose of the aircraft such that when the aircraft rests on a horizontal ground, the division plane is perpendicular to the horizontal ground. This is one way to take propulsive power out of the electrical engine mounting arrangement to a flying (airborne) vehicle like an airplane such that the mounting is symmetrical relative to the vehicle, or symmetrical-like relative to the vehicle, in other words, substantially symmetrical.

In an embodiment of the electrical engine mounting arrangement, each of the first side battery compartments has a first extension direction, and each of the first side battery compartments extends longitudinally along the first extension direction between the first side battery compartment bottom and the first side battery compartment top, and each of the second side battery compartments has a second extension direction, and each of the second side battery compartments extends longitudinally along the second extension direction between the second side battery compartment bottom and the second side battery compartment top. This is one advantageous way to arrange the one or more first side battery compartments and the one or more second side battery compartments.

In an embodiment of the electrical engine mounting arrangement,
each of the first side battery compartments has a shape of a longitudinal and rectangular parallelepiped extending to the outside of the mounting block, each of the first side battery compartments extending longitudinally in the first extension direction, and
each of the second side battery compartments has a shape of a longitudinal and rectangular parallelepiped extending to the outside of the mounting block, each of the second side battery compartments extending longitudinally in the second extension direction.

In an embodiment of the electrical engine mounting arrangement,
each of the first side battery compartments has a shape of a longitudinal circular cylinder extending to the outside of the mounting block, each of the first side battery compartments extending longitudinally in the first extension direction, and
each of the second side battery compartments has a shape of a longitudinal circular cylinder extending to the outside of the mounting block, each of the second side battery compartments extending longitudinally in the second extension direction.

In an embodiment of the electrical engine mounting arrangement,
each of the first side battery compartments has a shape of a longitudinal non-circular cylinder extending to the outside of the mounting block, each of the first side battery compartments extending longitudinally in the first extension direction, and
each of the second side battery compartments has a shape of a longitudinal non-circular cylinder extending to the outside of the mounting block, each of the second side battery compartments extending longitudinally in the second extension direction.

The three embodiments above are all advantageous, readily manufactured shapes for the first side battery compartments and for the second side battery compartments.

For example, the first side battery compartment walls and the second side battery compartment walls may be manufactured by extrusion of metal or by extrusion of plastic, or by extrusion of carbon fibre.

For example, the first side battery compartment walls and the second side battery compartment walls may be manufactured by moulding.

In an embodiment of the electrical engine mounting arrangement, the electrical engine mounting arrangement comprises two motor shafts, a first motor shaft and a second motor shaft, two electric motors, a first electric motor and a second electric motor, the first electric motor arranged to rotate the first motor shaft, and the second electric motor arranged to rotate the second motor shaft.

In an embodiment of the electrical engine mounting arrangement, the electrical engine mounting arrangement comprises: two power transfer shafts, a first power transfer shaft and a second power transfer shaft. The first power transfer shaft and the second power transfer shaft are concentric. The first power transfer shaft is arranged to rotate in response to the rotation of the first motor shaft. The second power transfer shaft is arranged to rotate in response to the rotation of the second motor shaft. A first propulsion element is attached fixedly to the first power transfer shaft, and a second propulsion element is attached fixedly to the second power transfer shaft.

In an embodiment of the electrical engine mounting arrangement, the electrical engine mounting arrangement comprises:
two motor shafts, a first motor shaft and a second motor shaft such that the first motor shaft and the second motor shaft are concentric and have a same axis of rotation, and
two electric motors, a first electric motor and a second electric motor, the first electric motor arranged to rotate the first motor shaft and the second electric motor arranged to rotate the second motor shaft. Two motors increase redundancy in power supply of the propulsion, which is important e.g. in airborne operations.

In an embodiment of the electrical engine mounting arrangement, the electrical engine mounting arrangement comprises:
two motor shafts, a first motor shaft and a second motor shaft such that the first motor shaft and the second motor shaft are concentric and have a same axis of rotation, and
two electric motors, a first electric motor and a second electric motor, the first electric motor and the second electric motor arranged successively along the first motor shaft and the second motor shaft,
the first electric motor arranged to rotate the first motor shaft, and the second electric motor arranged to rotate the second motor shaft. Successive placement is advantageous to keep the electric motors close to each other, e.g. for maintenance.

In an embodiment of the electrical engine mounting arrangement, the electrical engine mounting arrangement comprises:
two motor shafts, a first motor shaft and a second motor shaft such that the first motor shaft and the second motor shaft are concentric and have a same axis of rotation, and
two electric motors, a first electric motor at the first mounting block end of the mounting block and a second electric motor at the second mounting block end of the mounting block,
the first electric motor being arranged to rotate the first motor shaft, and the second electric motor being arranged to rotate the second motor shaft. The two ends of the mounting block may offer ample space for the location of the two electric motors.

In an embodiment of the electrical engine mounting arrangement, the electrical engine mounting arrangement comprises two power transfer shafts, a first power transfer shaft and a second power transfer shaft. The first power transfer shaft is attached to the first motor shaft in the direction of the first motor shaft such that the first power transfer shaft and the first motor shaft are concentric. The second power transfer shaft is attached to the second motor shaft in the direction of the second motor shaft such that the second power transfer shaft and the second motor shaft are concentric. The electrical engine mounting arrangement comprises a first propulsion element attached fixedly to the first power transfer shaft, and a second propulsion element attached fixedly to the second power transfer shaft. Attaching the propulsion element (e.g. a propeller) directly to the shaft is provides a reliable construction, as does directly joining the power transfer shafts and the corresponding motor shafts.

The first power transfer shaft and the first motor shaft may form a first straight drivetrain shaft.

The second power transfer shaft and the second motor shaft may form a second straight drivetrain shaft.

In an embodiment of the electrical engine mounting arrangement, the electrical engine mounting arrangement comprises two power transfer shafts, a first power transfer shaft and a second power transfer shaft. The first power transfer shaft is attached to the first motor shaft in the direction of the first motor shaft such that the first power transfer shaft and the first motor shaft are concentric. The second power transfer shaft is attached to the second motor shaft in the direction of the second motor shaft such that the second power transfer shaft and the second motor shaft are concentric. The electrical engine mounting arrangement comprises a first propulsion element attached fixedly to the first power transfer shaft, and a second propulsion element attached fixedly to the second power transfer shaft such that the first propulsion element and the second propulsion element are arranged to rotate in opposite directions. Attaching the propulsion element (e.g. a propeller) directly to the shaft is provides a reliable construction. Propellers that rotate in opposite directions (that is, contra-rotating propellers) are advantageous as they balance the force or torque that tends to turn, roll or yaw the vehicle to one direction.

The electrical engine mounting arrangement is thus very advantageous for vehicles capable of powered flight like aircrafts, as it may provide a yaw-free thrust and a rapid throttle response (that is, increasing or decreasing power for propulsion has a fast effect on the actual propulsion power generated by the electrical engine mounting arrangement).

In an embodiment of the electrical engine mounting arrangement, the electric motor is located between the one or more first side battery compartments and the one or more second side battery compartments. This shortens the electrical engine mounting arrangement.

In an embodiment of the electrical engine mounting arrangement, the first electric motor is located between the one or more first side battery compartments and the one or more second side battery compartments, and the second electric motor is located between the one or more first side battery compartments and the one or more second side battery compartments. This shortens the electrical engine mounting arrangement.

In an embodiment of the electrical engine mounting arrangement, the electrical engine mounting arrangement comprises
a cooling air duct,
a first side interposed volume between the first side battery compartment and the at least one first side battery,
a second side interposed volume between the second side battery compartment and the at least one second side battery,
a first flow connection between the cooling air duct and the first side interposed volume,
a second flow connection between the cooling air duct and the second side interposed volume,
the cooling air duct comprising an air intake, the cooling air duct arranged to:
take in cooling air from an airflow in the vicinity of the electrical engine mounting arrangement through the air intake, and
feed the cooling air to the first side interposed volume through the first flow connection and to the second side interposed volume through the second flow connection. This is an advantageous arrangement for cooling the batteries of the arrangement especially when the vehicle is moving.

In an embodiment of the electrical engine mounting arrangement,
the electrical engine mounting arrangement comprises a normal plane having the rotation axis as a normal direction,
a first projection of each of the first extension directions on the normal plane has an intersection angle α between a second projection of each of the second extension directions on the normal plane such that:
the intersection angle α is between 30°-130°; or
the intersection angle α is between 60°-120°; or
the intersection angle α is between 80°-100°; or
the intersection angle α is between 230°-330°; or
the intersection angle α is between 240°-300°; or
the intersection angle α is between 260°-280°.

These arrangements provide an easy access to the batteries.

In an embodiment of the electrical engine mounting arrangement, when viewed in the direction of the rotation axis, the first side battery compartment and the second side battery compartment form together with the mounting block: a V-shaped shape; or an upside down V-shaped shape. These arrangements provide an easy access to the batteries.

The upside down V-shaped shape forms a Greek capital lambda (A) shaped shape.

In an embodiment of the electrical engine mounting arrangement, the first extension direction of each of the first side battery compartments and the second extension direction of each of the second side battery compartments have opposite directions. Opposite arrangement enables the usage of a long and straight battery that occupies at least part of the first and second side battery compartments.

In an embodiment of the electrical engine mounting arrangement,
the first extension direction of each of the first side battery compartments and the second extension direction of each of the second side battery compartments have opposite directions, and
each of the first side battery compartments and each of the second side battery compartments are arranged to house a combined battery unit, the combined battery unit comprising the at least one first side battery and the at least one second side battery. Opposite arrangement enables the usage of a long and straight battery that occupies at least part of the first and second side battery compartments. Such a battery is easy to handle, and cuts down the number of batteries, yet maintaining balance in terms of center of gravity.

In an embodiment of the electrical engine mounting arrangement,
each of the first side battery compartments has an opposing second side battery compartment at the other side of the division plane, the opposing second side battery compartment being one of the second side battery compartments.

In an embodiment of the electrical engine mounting arrangement,
each of the first side battery compartments has an opposing second side battery compartment at the other side of the division plane, the opposing second side battery compartment being one of the second side battery compartments, and
each of the first side battery compartments and each of the opposing second side battery compartments are arranged to house a combined battery unit, the combined battery unit comprising at least one first side battery and at least one second side battery. Opposite arrangement enables the usage of a long and straight battery that occupies at least part of the first and second side battery compartments.

In an embodiment of the electrical engine mounting arrangement,
each of the first side batteries and each of the second side batteries belong either to a first battery group or to a second battery group,
the first battery group is arranged to supply energy to the first electric motor, and
the second battery group is arranged to supply energy to the second electric motor. This is a way to increase the redundancy in the distribution of electrical power to the electric motors.

In an embodiment of the electrical engine mounting arrangement,
each of the first side batteries belong to a first battery group,
each of the second side batteries belong to a second battery group,
the first battery group is arranged to supply energy to the first electric motor, and
the second battery group is arranged to supply energy to the second electric motor. This is a way to increase the redundancy in the distribution of electrical power to the electric motors.

In an embodiment of the electrical engine mounting arrangement,
each of the first side batteries belong to a second battery group,
each of the second side batteries belong to a first battery group,
the first battery group is arranged to supply energy to the first electric motor, and
the second battery group is arranged to supply energy to the second electric motor. This is a way to increase the redundancy in the distribution of electrical power to the electric motors.

In an embodiment of the electrical engine mounting arrangement,
each of the first side battery compartments comprises a first side lid at the first side battery compartment top of each of the first side battery compartments,
each of the first side battery compartment tops is arranged to be closed with the first side lid,
each of the second side battery compartments comprises a second side lid at the second side battery compartment top of each of the second side battery compartments, and
each of the second side battery compartment tops is arranged to be closed with the second side lid. A lid is advantageous to stop the ingress of dirt or moisture into the compartment

In an embodiment of the electrical engine mounting arrangement,
each of the first side batteries is arranged to supply energy to the electric motor through a first side electrical lid connector arranged at the first side lid, and
each of the second side batteries is arranged to supply energy to the electric motor through a second side electrical lid connector arranged at the second side lid. The lids may be also used for the purposes of providing electrical connections to the batteries.

In an embodiment of the electrical engine mounting arrangement,
the electrical engine mounting arrangement comprises a first side combination lid,
each of the first side battery compartment tops is arranged to be closed with the first side combination lid,
the electrical engine mounting arrangement comprises a second side combination lid, and
each of the second side battery compartment tops is arranged to be closed with the second side combination lid. Again, lid is advantageous for blocking ingress of moisture and dirt. One lid may serve many battery compartments, which provides a simple construction.

In an embodiment of the electrical engine mounting arrangement,
each of the first side batteries is arranged to supply energy to the electric motor through a first side electrical lid connector arranged at the first side combination lid, and
each of the second side batteries is arranged to supply energy to the electric motor through a second side electrical lid connector arranged at the second side combination lid.

In an embodiment of the electrical engine mounting arrangement,
each of the first side batteries is arranged to supply energy to the electric motor through cables electrically connected to the first side battery with a first side battery connector, and
each of the second side batteries is arranged to supply energy to the electric motor through cables electrically connected to the second side battery with a second side battery connector. Cables may be also used for the purposes of providing electrical connections to the batteries.

In an embodiment of the electrical engine mounting arrangement,
each of the first side battery compartments comprises a first side electrical bottom connector arranged at the first side battery compartment bottom of the first side battery compartment, and the at least one first side battery is arranged to supply energy to the electric motor through a first side electrical bottom connector, and
each of the second side battery compartments comprises a second side electrical bottom connector arranged at the second side battery compartment bottom of the second side battery compartment, and the at least one second side battery is arranged to supply energy to the electric motor through a second side electrical bottom connector. The bottoms of the battery compartments may be also used for the purposes of providing electrical connections or connectors to the batteries.

An advantage of the invention is that the disclosed electrical engine mounting arrangement is well-balanced especially in terms of center of gravity, the batteries are easy to access and replace, and the ohmic losses between the batteries and the motor are decreased.

### BRIEF DESCRIPTION OF THE DRAWINGS

The invention is described in detail by means of specific embodiments with reference to the enclosed drawings, in which

FIG. 1a shows a schematic frontal view of an electrical engine mounting arrangement according to an embodiment of the invention,

FIG. 1b shows a schematic side view of an electrical engine mounting arrangement according to an embodiment of the invention,

FIG. 2a shows a schematic side view of an electrical engine mounting arrangement according to an embodiment of the invention,

FIG. 2b and FIG. 2c show an I-beam construction for the mounting arrangement according to embodiments,

FIG. 2d and FIG. 2e show a triangular beam construction for the mounting arrangement according to embodiments,

FIG. 2f shows a tubing frame for attaching the mounting arrangement according to embodiments,

FIG. 3a and FIG. 3b show a schematic top side view of an electrical engine mounting arrangement according to embodiments of the invention,

FIG. 4a and FIG. 4b show a schematic frontal view of an electrical engine mounting arrangement according to embodiments of the invention such that the arrangement is attached to a vehicle, or arrangements are attached to a vehicle,

FIG. 5 shows an isometric 3D view of an electrical engine mounting arrangement according to an embodiment of the invention,

FIG. 6a shows a schematic frontal view of an electrical engine mounting arrangement according to another embodiment of the invention,

FIG. 6b shows schematically a projection plane,

FIG. 6c shows a schematic frontal view of an electrical engine mounting arrangement according to another embodiment of the invention with a propulsion unit attached to the electrical engine mounting arrangement,

FIG. 6d shows a schematic frontal view of an electrical engine mounting arrangement according to another embodiment of the invention,

FIG. 6e shows schematically another projection plane,

FIGS. 7-8 show schematically embodiments related to cooling of the electrical engine mounting arrangement,

FIG. 9 shows a schematic frontal view of an electrical engine mounting arrangement according to another embodiment of the invention,

FIG. 10 shows a schematic side view of an electrical engine mounting arrangement according to another embodiment of the invention,

FIG. 11 shows an embodiment with opposing first and second side battery compartments,

FIGS. 12-14 show schematically groupings of batteries in embodiments of the invention,

FIG. 15a and FIG. 15b show schematically arrangements related to battery compartment lids, and

FIGS. 16-18 show schematically embodiments related to electrical arrangements.

### DETAILED DESCRIPTION OF THE INVENTION

In the present text and in the associated Figures, like numbers (for example 42) and like labels (for example 21b) denote like elements.

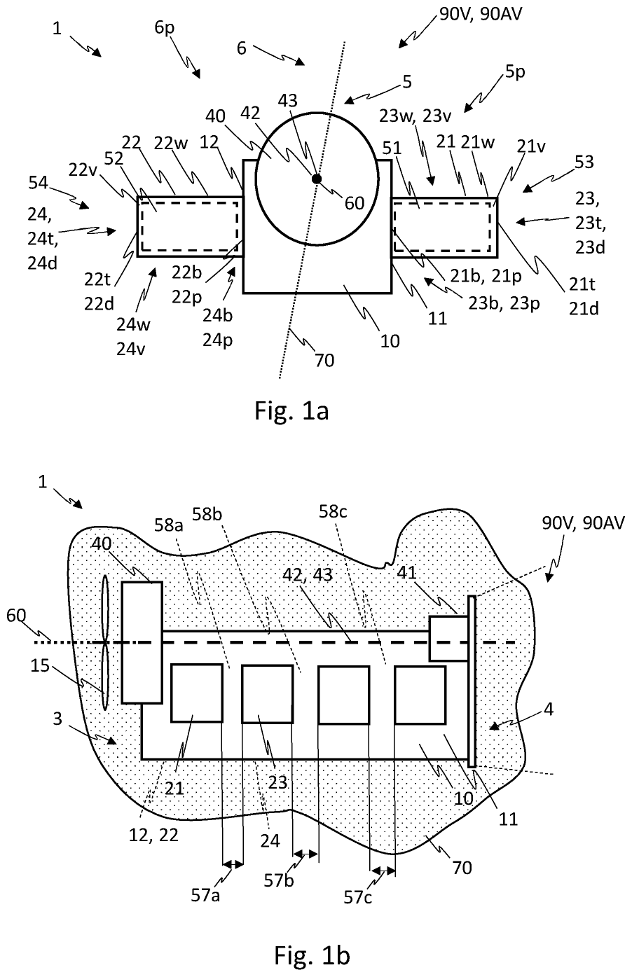

FIG. 1a shows an aspect of the invention, an electrical engine mounting arrangement 1 for providing propulsion power to a vehicle 90V. The electrical engine mounting arrangement 1 comprises A) a mounting block 10, B) an electric motor 40, 41 fixedly attached to the mounting block 10, and C1) a motor shaft 42.

The vehicle 90V may be an aircraft 90AV, e.g. an airplane, or a boat, a watercraft, a road vehicle or an off-road vehicle.

Propulsive force from the electrical mounting arrangement may be arranged to the vehicle through wheels such that propulsion power of the motor is coupled to the wheels of the vehicle.

Propulsive force from the electrical mounting arrangement may be arranged to the vehicle through a propeller that rotates by propulsion power provided by the electric motor.

The propulsive power may be coupled to one or more propulsors like one or more wheels or one or more propellers.

The propulsor may then generate the force that provides the propulsive force that drives (e.g. moves or turns) the vehicle.

The vehicle 90V may be a manned vehicle, for example a light aircraft.

The vehicle 90V may be an unmanned vehicle, for example a drone or an unmanned aerial vehicle.

The electric motor 40 is arranged to rotate the motor shaft 42.

The electrical engine mounting arrangement 1 comprises also C2) a power transfer shaft 43. The power transfer shaft 43 is arranged to rotate in response to the rotation of the motor shaft 42.

The power transfer shaft 43 is aligned along a rotation axis 60 such that the rotation axis 60 lies on a division plane 70.

The rotation axis 60 is the rotation axis of the power transfer shaft 43.

The division plane 70 is a fictitious plane with the purpose of defining features of the present invention.

The division plane 70 may be vertical when the vehicle 90V, 90AV is arranged in its normal resting position, e.g. an aircraft 90AV parked on a horizontal apron, or a boat resting and docked in calm water.

The division plane 70 may be aligned with the direction of gravity when the vehicle 90V, 90AV is arranged in its normal resting position, e.g. an aircraft 90AV parked on a horizontal apron, or a boat resting and docked in calm water such that the normal direction of the division plane 70 is perpendicular to the direction of gravity.

The division plane 70 is arranged to split the electrical engine mounting arrangement 1 into two portions. A first portion 5p lies at a first side 5 of the division plane 70, and a second portion 6p lies at a second side 6 of the division plane 70.

The first portion 5p of the electrical engine mounting arrangement lies on the first side 5 of the division plane 70, and the second portion 6p of the electrical engine mounting arrangement lies on the second side 6 of the division plane 70.

Referring also to FIG. 1b which is a side view of the electrical engine mounting arrangement 1 in addition to FIG. 1a, the electrical engine mounting arrangement 1 comprises D) one or more first side battery compartments 21, 23 fixedly attached to the mounting block 10 at the first side 5 of a division plane 70. Each of the first side battery compartments 21, 23 comprises a first side battery compartment top 21t, 23t and a first side battery compartment bottom 21b, 23b. Each of the first side battery compartments 21, 23 comprises also one or more first side battery compartment walls 21w, 23w between the first side battery compartment top 21t, 23t and the first side battery compartment bottom 21b, 23b. Unit 23 and its parts are behind unit 21 in FIG. 1a.

The first side battery compartment top 21t, 23t, the first side battery compartment bottom 21b, 23b and the first side battery compartment walls 21w, 23w define a first inner volume 21v, 23v of the first side battery compartment 21, 23 (unit 23w is behind unit 21w, and unit 23v behind unit 21v in FIG. 1a). The first inner volume 21v, 23v of the first side battery compartment 21 is arranged to house at least part of at least one first side battery 51, 53 such that the at least one first side battery 51, 53 is detachable (battery 53 is behind battery 51 in FIG. 1a). The at least one first side battery 51, 53 is arranged to supply energy to the electric motor 40 for rotating the motor shaft 42.

A propulsion element 15 may be attached to the power transfer shaft 43.

The power transfer shaft 43 may be arranged to provide propulsive power from the motor shaft 42 to the propulsion element 15.

The motor shaft 42 and the power transfer shaft 43 may be two parts of a straight drivetrain shaft.

The motor shaft 42 and the power transfer shaft 43 may form a straight drivetrain shaft.

The power transfer shaft 43 may arranged to rotate in response to the rotation of the motor shaft 42 such that the power transfer shaft 43 and the motor shaft 42 are linked with a first belt, a first chain or first cogwheels or any combination thereof.

The power transfer shaft 43 may be attached to the motor shaft 42 directly, in the direction of the motor shaft 42.

The power transfer shaft 43 may be arranged to continue the motor shaft 42 directly, in the direction of the motor shaft 42.

More specifically, each of the one or more first side battery compartment walls 21w, 23w comprises an inner surface and an outer surface.

The inner surfaces of each of the first side battery compartment walls 21w, 23w define the first inner volume 21v, 23v.

The first side battery compartment walls 21w, 23w may be made of sheets of carbon fibre, thin metal sheet like aluminium, rigid plastic, glass fibre or aramid fibre.

Thickness of the first side battery compartment walls 21w, 23w may be for example 0.5 mm-3 mm.

The first side battery 51, 53 may be detachable or removable such that the first side battery 51, 53 can be attached removably, e.g. locked, into the first side battery compartment 21, 23 with one or more mechanical connectors.

The first side battery 51, 53 may be detachable such that it can be inserted and removed from the first side battery compartment 21, 23.

The first side battery 51, 53 may be detachable such that it can be inserted and removed from the first side battery compartment 21, 23 through the first side battery compartment top 21t, 23t.

The first side battery 51, 53 may be detachable such that the first side battery 51, 53 can be inserted and removed from the first side battery compartment 21, 23 without breaking structure of the electrical engine mounting arrangement 1.

Insertion and removal of the first side battery 51, 53 may be arranged through the first side battery compartment top 21t, 23t.

The first side battery compartment top 21t, 23t may comprise an opening in the first side battery compartment 21, 23.

The one or more first side battery compartments 21, 23 may be located entirely at the first side 5 of the division plane 70.

The electrical engine mounting arrangement 1 comprises also E) one or more second side battery compartments 22, 24 fixedly attached to the mounting block 10 at a second side 6 of the division plane 70. Each of the second side battery compartments 22, 24 comprises a second side battery compartment top 22t, 24t, and a second side battery compartment bottom 22b, 24b. Each of the second side battery compartments 22, 24 comprises also one or more second side battery compartment walls 22w, 24w between the second side battery compartment top 22t, 24t and the second side battery compartment bottom 22b, 24b. Again, units 24, 24b, 24p, 24t, and 24d are behind units 22, 22b, 22p, 22t, and 22d in FIG. 1a, respectively.

The second side battery compartment top 22t, 24t, the second side battery compartment bottom 22b, 24b and the second side battery compartment walls 22w, 24w define a second inner volume 22v, 24v of the second side battery compartment 22, 24. The second inner volume 22v, 24v of the second side battery compartment 22 is arranged to house at least part of at least one second side battery 52, 54 such that the at least one second side battery 52, 54 is detachable. The at least one second side battery 52, 54 is arranged to supply energy to the electric motor 40 for rotating the motor shaft 42. Units 24v and 24w are behind units 22v and 22w in FIG. 1a, respectively.

More specifically, each of the one or more second side battery compartment walls 22w, 24w comprises an inner surface and an outer surface.

The inner surfaces of each of the second side battery compartment walls 22w, 24w define the second inner volume 22v, 24v.

The second side battery compartment walls 22w, 24w may be made of sheets of carbon fibre, thin metal sheet like aluminium, rigid plastic, glass fibre or aramid fibre.

Thickness of the second side battery compartment walls 22w, 24w may be for example 0.5 mm-3 mm.

The second side battery 52, 54 may be detachable or removable such that the second side battery 52, 54 can be attached removably, e.g. locked, into the second side battery compartment 22, 24 with one or more mechanical connectors.

The second side battery 52, 54 may be detachable such that the second side battery 52, 54 can be inserted and removed from the second side battery compartment 22, 24 without breaking structure of the electrical engine mounting arrangement 1.

The second side battery 52, 54 may be detachable such that it can be inserted and removed from the second side battery compartment 22, 24.

The first side battery 51, 53 may be detachable such that it can be inserted and removed from the first side battery compartment 21, 23 through the second side battery compartment top 22t, 24t.

Insertion and removal of the second side battery 52, 54 may be arranged through the second side battery compartment top 22t, 24t.

The second side battery compartment top 22t, 24t may comprise an opening in the second side battery compartment 22, 24.

The one or more second side battery compartments 22, 24 may be located entirely at the second side 6 of the division plane 70.

One first side battery compartment 21, 23 may house more than one first side batteries 51, 53.

One second side battery compartment 22, 24 may house more than one second side batteries 52, 54.

One first side battery compartment 21, 23 may house one first side battery 51, 53.

One second side battery compartment 22, 24 may house one second side battery 52, 54.

The first side battery compartment 21, 23 may be manufactured from carbon fibre or glass fibre or aluminium.

The second side battery compartment 22, 24 may be manufactured from carbon fibre or glass fibre or aluminium.

Such a hard material provides mechanical protection to the first side battery 51, 53 and second side battery 52, 54.

The mounting block 10 may be manufactured from metal, e.g. steel or aluminium.

The mounting block 10 may be manufactured from sheet metal, e.g. sheet steel or sheet aluminium.

The mounting block 10 may be manufactured from carbon fibre or glass fibre.

A benefit of the invention is to be able to provide short cabling or other such connection between the first side battery 51, 53 and the electric motor 40 and the second side battery 52, 54 and the electric motor 40.

For example, in contrast to a solution where the vehicle 90V is an aircraft 90AV, and the batteries are placed in wings, and the electric motor at the nose of the aircraft 90AV, with the invention, the electrical connections can be made considerably shorter.

The first side battery 51, 53 and the second side battery 52, 54 may have a terminal DC voltage of 60V or less. Such voltages are generally considered non-hazardous for humas.

In an embodiment, as shown in FIG. 1a, the first side battery compartment top 21t, 23t is located at a first distal end 21d, 23d of the first side battery compartment 21, 23.

In an embodiment, as shown in FIG. 1a, the first side battery compartment bottom 21b, 23b is located at a first proximal end 21p, 23p of the first side battery compartment 21, 23, the first proximal end 21p, 23p being closer to the mounting block 10 than the first distal end 21d, 23d.

In an embodiment, as shown in FIG. 1, the second side battery compartment top 22t, 24t is located at a second distal end 22d, 24d of the second side battery compartment 22, 24.

In an embodiment, as shown in FIG. 1a, the second side battery compartment bottom 22b, 24b is located at a second proximal end 22p, 24p of the second side battery compartment 22, 24, the second proximal end 22p, 24p being closer to the mounting block 10 than the second distal end 22d, 24d.

As shown in FIG. 1b, in an embodiment, the mounting block 10 comprises a first mounting block end 3 and a second mounting block end 4 opposite the first mounting block end 3.

As also shown in FIG. 1b, in an embodiment, the mounting block 10 comprises a first mounting block end 3 and a second mounting block end 4 opposite the first mounting block end 3, and the electrical engine mounting arrangement 1 is arranged to be attached to the vehicle 90V, 90VA at the second mounting block end 4.

The mounting block 10 may also comprise a first mounting block side 11 extending between the first mounting block end 3 and the second mounting block end 4 at the first side 5 of the division plane 70, and a second mounting block side 12 extending between the first mounting block end 3 and the second mounting block end 4 at the second side 6 of the division plane 70 (in FIG. 1b, second mounting block side is behind the first mounting block side 11).

The second mounting block end 4 is opposite to the first mounting block end 3.

Still referring to FIG. 1b, in an embodiment, the electrical engine mounting arrangement 1 comprises more than one first side battery compartments 21, 23. Each of the first side battery compartments 21, 23 is separated from an adjacent first side battery compartment 21, 23 with a first side gap 57a, 57b, 57c.

Each of the first side battery compartments 21, 23 is separated from the adjacent first side battery compartment 21, 23 with a first side gap 57a, 57b, 57c.

Each of the first side gaps 57a, 57b, 57c may have a different length.

Each of the first side gaps 57a, 57b, 57c span a distance determined from the outer surfaces of the first side battery compartment walls 21w, 23w.

The electrical engine mounting arrangement 1 comprises also more than one second side battery compartments 22, 24. Each of the second side battery compartments 22, 24 is separated from an adjacent second side battery compartment 22, 24 with a second side gap 58a, 58b, 58c.

Each of the second side battery compartments 22, 24 is separated from the adjacent second side battery compartment 22, 24 with a second side gap 58a, 58b, 58c.

Each of the second side gaps 58a, 58b, 58c may have a different length.

Each of the second side gaps 58a, 58b, 58c span a distance determined from the outer surfaces of the second side battery compartment walls 22w, 24w.

In FIG. 1b, the units at the second side 6 are invisible as they lie behind the mounting block 10.

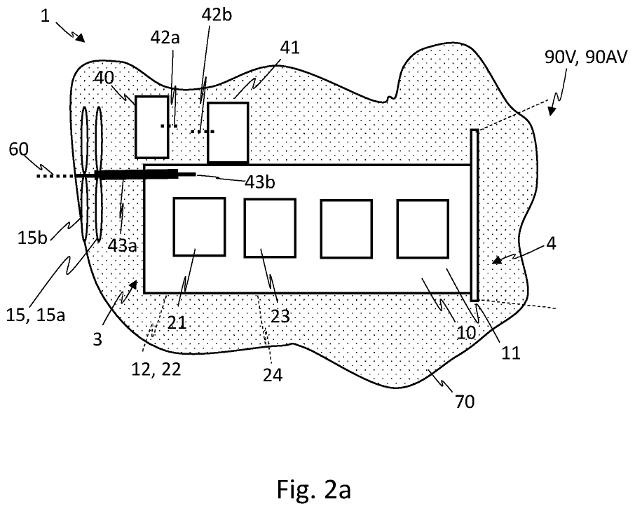

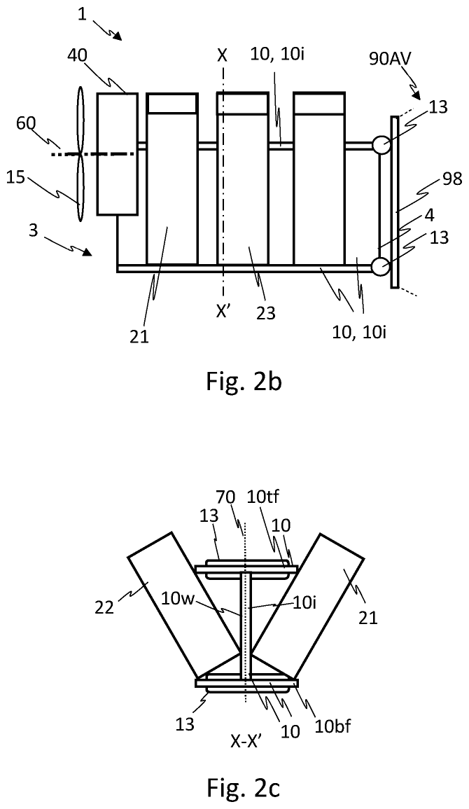

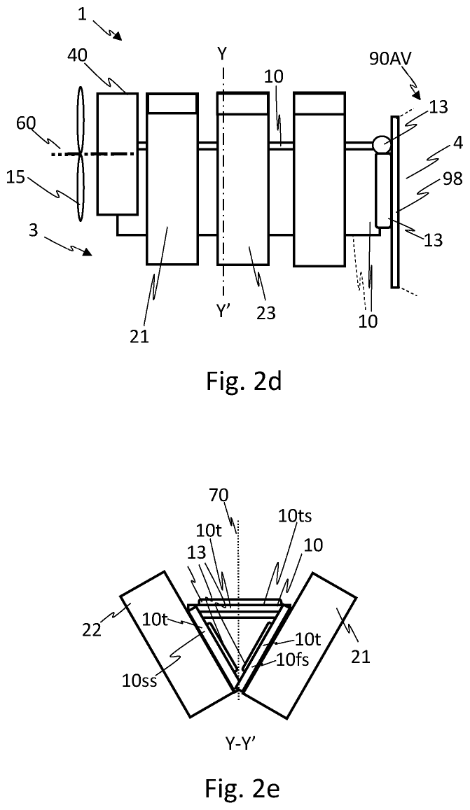

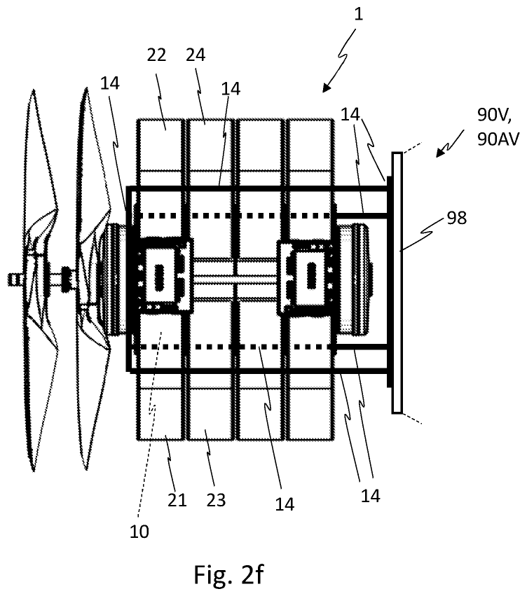

In an embodiment of the electrical engine mounting arrangement 1, and referring now to FIG. 2b and FIG. 2c, the mounting block 10 comprises an I-beam 10i extending between the first mounting block end 3 and the second mounting block end 4.

In an embodiment of the electrical engine mounting arrangement 1, and referring still to FIG. 2b and FIG. 2c, the mounting block 10 comprises an I-beam 10i extending between the first mounting block end 3 and the second mounting block end 4, the I-beam 10i comprises a top flange 10tf, a bottom flange 10bf and a web 10w, and the one or more first side battery compartments 21, 23 are fixedly attached to the top flange 10tf, to the bottom flange 10bf and to the web 10w, and the one or more second side battery compartments 22, 24 are fixedly attached to the top flange 10tf, to the bottom flange 10bf and to the web 10w.

In an embodiment and as shown in FIG. 2c, the web 10w of the I-beam 10i is parallel to the division plane 70.

In an embodiment, the web 10w of the I-beam 10i lies on the division plane 70.

The electrical engine mounting arrangement 1 may be connected to the vehicle 90V, 90AV with one or more mounting brackets 13.

In an embodiment, the aircraft 90AV comprises a firewall 98 at the nose of the aircraft 90AV, and the electrical engine mounting arrangement 1 is connected to the firewall 98 of the aircraft 90AV with one or more mounting brackets 13.

In an embodiment of the electrical engine mounting arrangement 1, and referring now to FIG. 2d and FIG. 2e, the mounting block 10 comprises a triangular cross section beam 10t extending between the first mounting block end 3 and the second mounting block end 4.

In an embodiment of the electrical engine mounting arrangement 1, and referring still to FIG. 2d and FIG. 2e, the mounting block 10 comprises a triangular cross section beam 10t extending between the first mounting block end 3 and the second mounting block end 4, the triangular cross section beam 10t comprises a top section 10ts split by the division plane 70, a first side section 10fs at the first side 5 of the division plane 70, and a second side section 10ss at the second side 6 of the division plane 70. The one or more first side battery compartments 21, 23 are fixedly attached to the first side section 10fs, and the one or more second side battery compartments 22, 24 are fixedly attached to the second side section 10ss.

In an embodiment of the electrical engine mounting arrangement 1, and referring now to FIG. 2f, the electrical engine mounting arrangement 1 is attached fixedly to a tubing frame 14, the tubing frame 14 comprising interjoined tubing sections, and the electrical engine mounting arrangement 1 is attached to the vehicle 90V, 90AV with the tubing frame 14.

Still referring to FIG. 2f, in an embodiment, the aircraft 90AV comprises a firewall 98 at the nose of the aircraft 90AV, and the electrical engine mounting arrangement 1 is connected to the firewall 98 of the aircraft 90AV with the tubing frame 14.

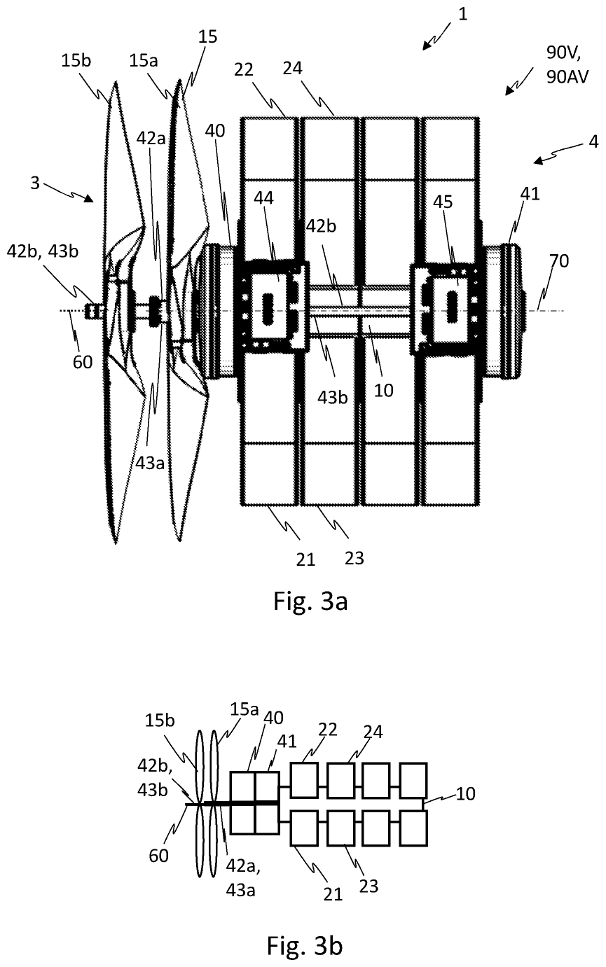

In an embodiment, and referring now to FIG. 2a and FIG. 3a, a topside view, the electrical engine mounting arrangement 1 comprises a propulsion element 15, 15a, 15b. The propulsion element 15, 15a, 15b is arranged to provide propulsion to the vehicle 90V, 90AV in response to the rotation of the power transfer shaft 43, 43a, 43. The electrical engine mounting arrangement 1 is fixedly attached to the vehicle 90V, 90AV.

The propulsion element 15, 15a, 15b may be a propulsor.

The propulsion element 15, 15a, 15b may be a propeller.

FIG. 3a shows also a control unit 44 and a control unit 45.

The control unit 44 may be arranged to control the flow of electrical energy from the one or more batteries 51, 52, 53, 54 to the electric motor 40.

The control unit 45 may be arranged to control the flow of electrical energy from the one or more batteries 51, 52, 53, 54 to the electric motor 40.

The control unit 44 may be arranged to control the flow of electrical energy from the one or more batteries 51, 52, 53, 54 to the first electric motor 40, and the control unit 45 may be arranged to control the flow of electrical energy from the one or more batteries 51, 52, 53, 54 to the second electric motor 41.

In an embodiment, and still referring to FIG. 3a, the electrical engine mounting arrangement 1 comprises a propulsion element 15, 15a, 15b attached to the power transfer shaft 43, 43a, 43b. The propulsion element 15, 15a, 15b is arranged to provide propulsion to the vehicle 90V in the direction of the power transfer shaft 43, 43a, 43b. The electrical engine mounting arrangement 1 is fixedly attached to the vehicle 90V.

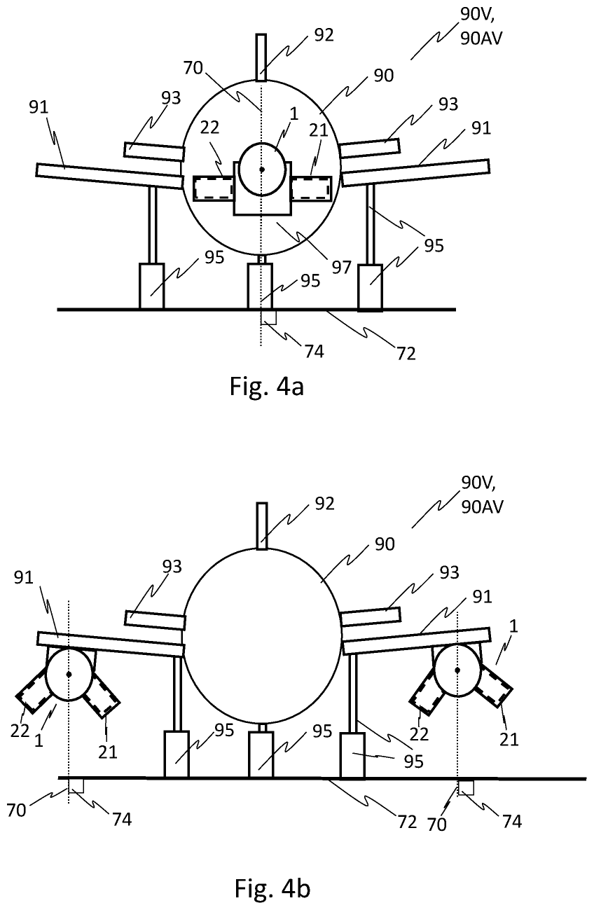

In an embodiment, and referring to FIGS. 3a and 4a, the electrical engine mounting arrangement 1 comprises a propulsion element 15, 15a, 15b attached to the power transfer shaft 43, 43a, 43b. The propulsion element 15, 15a, 15b is arranged to provide propulsion to an aircraft 90AV. The propulsion is provided in the direction of the power transfer shaft 43, 43a, 43b. The electrical engine mounting arrangement 1 is fixedly attached to a nose of the aircraft 90AV.

In an embodiment, and referring to FIGS. 3a and 4b, the electrical engine mounting arrangement 1 comprises a propulsion element 15, 15a, 15b attached to the power transfer shaft 43, 43a, 43b. The propulsion element 15, 15a, 15b is arranged to provide propulsion to an aircraft 90AV in the direction of the power transfer shaft 43, 43a, 43b. The electrical engine mounting arrangement 1 is fixedly attached to a wing 91 of the aircraft 90AV.

For an aircraft 90AV with two wings 91, two electrical engine mounting arrangements 1 may be provided, one for each of the wings, as in FIG. 4b.

For an aircraft 90AV with two wings, three electrical engine mounting arrangements 1 may be provided, one for each of the wings and one at the nose of the aircraft (this embodiment is not shown in the Figures).

For an aircraft 90AV with two wings, four electrical engine mounting arrangements 1 may be provided, two for each of the wings (this embodiment is not shown in the Figures).

In an embodiment, and referring to FIG. 4a, the electrical engine mounting arrangement 1 comprises a propulsion element 15, 15a, 15b attached to the power transfer shaft 43, 43a, 43b, the propulsion element 15, 15a, 15b arranged to provide propulsion to an aircraft 90AV in the direction of the power transfer shaft 43, 43a, 43b, the electrical engine mounting arrangement 1 being fixedly attached to a nose of the aircraft 90AV such that when the aircraft 90AV rests on a horizontal ground 72, the division plane 70 is perpendicular (shown with label 74) to the horizontal ground 72.

FIG. 4a and FIG. 4b show also schematically parts of the aircraft 90AV, e.g. an airplane, with fuselage 90, wings 91, horizontal stabilizers 93, vertical stabilizer 92 and undercarriages 95.

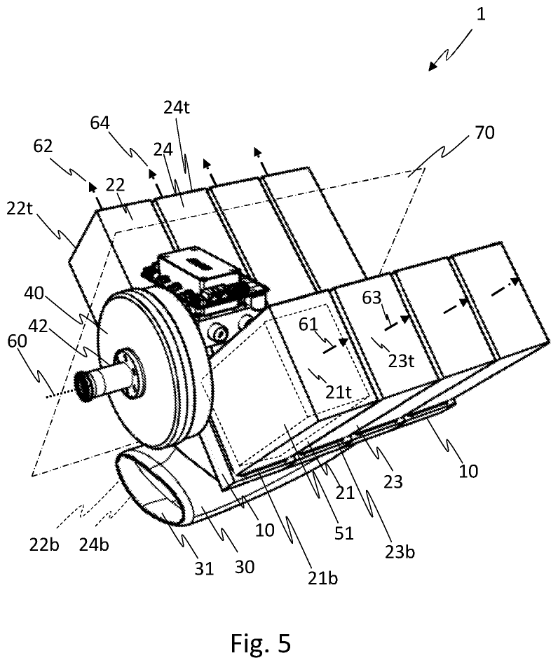

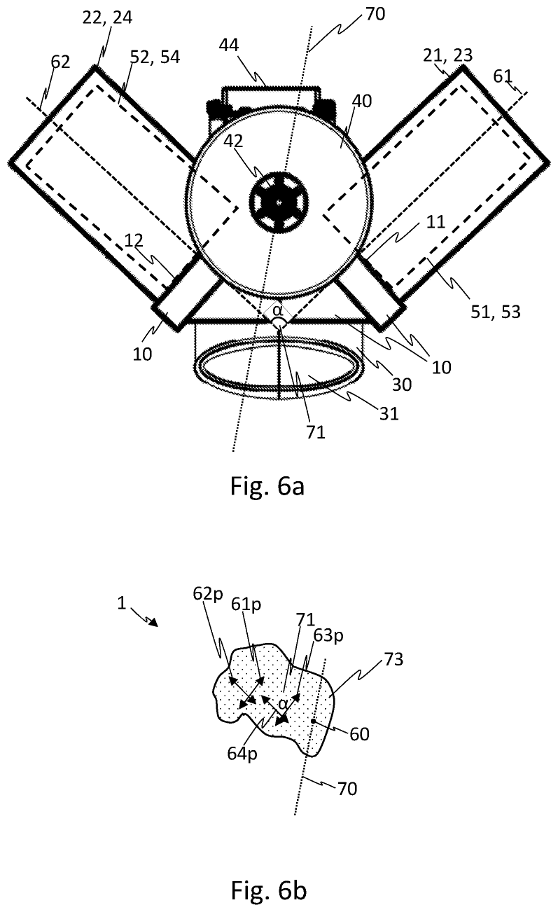

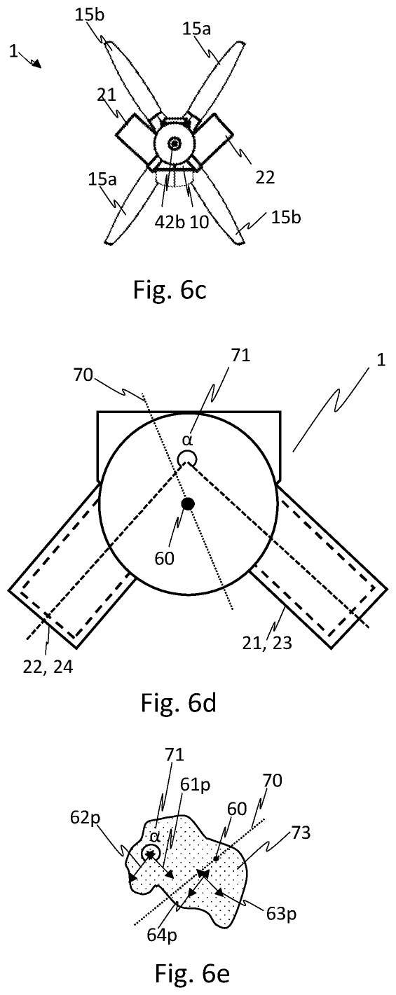

In an embodiment, and referring to FIGS. 5 and 6a, each of the first side battery compartments 21, 23 has a first extension direction 61, 63, and each of the first side battery compartments 21, 23 extends longitudinally along the first extension direction 61, 63 between the first side battery compartment bottom 21b, 23b and the first side battery compartment top 21t, 23t.

Each of the second side battery compartments 22, 24 has a second extension direction 62, 64, and each of the second side battery compartments extends longitudinally along the second extension direction 62, 64 between the second side battery compartment bottom 22b, 24b and the second side battery compartment top 22t, 24t.

Each of the first extension directions 61, 63 may be the same as the other first extension directions 61, 63.

Each of the first extension directions 61, 63 may be the different from the other first extension directions 61, 63.

At least one of the first extension directions 61, 63 may be different from the other first extension directions 61, 63.

Each of the second extension directions 62, 64 may be the same as the other second extension directions 62, 64.

Each of the second extension directions 62, 64 may be the different from the other second extension directions 62, 64.

At least one of the second extension directions 62, 64 may be different from the other second extension directions 62, 64.

Each of the first extension directions 61, 63 may have a component which is parallel to the rotation axis 60.

Each of the second extension directions 62, 64 may have a component which is parallel to the rotation axis 60.

Each of the first extension directions 61, 63 may have a component which is perpendicular to the rotation axis 60.

Each of the second extension directions 62, 64 may have a component which is perpendicular to the rotation axis 60.

Each of the first extension directions 61, 63 and each of the second extension directions 62, 64 may have a same component parallel to the rotation axis 60.

This means that each of the first side battery compartments 21, 23 and each of the second side battery compartments 22, 24 are slanted forwards of backwards relative to the rotation axis 60 by the same angle relative to the rotation axis 60.

Each of the first extension directions 61, 63 may be aligned through the center of each of the first side battery compartment tops 21t, 23t, and through the center of each of the first side battery compartment bottoms 21b, 23b.

Each of the second extension directions 62, 64 may be aligned through the center of each of the second side battery compartment tops 22t, 24t, and through the center of each of the second side battery compartment bottoms 22b, 24b.

Referring to FIGS. 5 and 6a, in an embodiment, each of the first side battery compartments 21, 23 has a shape of a longitudinal and rectangular parallelepiped extending to the outside of the mounting block 10. Each of the first side battery compartments 21, 23 extends longitudinally in the first extension direction 61, 63. Each of the second side battery compartments 22, 24 has a shape of a longitudinal and rectangular parallelepiped extending to the outside of the mounting block 10. Each of the second side battery compartments 22, 24 extends longitudinally in the second extension direction 62, 64.

Thus, each of the first side battery compartments 21, 23 and each of the second side battery compartments 22, 24 may have four walls.

In an embodiment, each of the first side battery compartments 21, 23 has a shape of a longitudinal circular cylinder (this shape not shown in Figures) extending to the outside of the mounting block 10. Each of the first side battery compartments 21, 23 extends longitudinally in the first extension direction 61, 63. Each of the second side battery compartments 22, 24 has a shape of a longitudinal circular cylinder (this shape not shown in Figures) extending to the outside of the mounting block 10. Each of the second side battery compartments 22, 24 extends longitudinally in the second extension direction 62, 64.

Thus, each of the first side battery compartments 21, 23 and each of the second side battery compartments 22, 24 may have one wall 21w, 23w, 22w, 24w which is the mantle of the circular cylinder.

In an embodiment, each of the first side battery compartments 21, 23 has a shape of a longitudinal non-circular cylinder (this shape not shown in Figures) extending to the outside of the mounting block 10. Each of the first side battery compartments 21, 23 extend longitudinally in the first extension direction 61, 63. Each of the second side battery compartments 22, 24 has a shape of a longitudinal non-circular cylinder (this shape not shown in Figures) extending to the outside of the mounting block 10. Each of the second side battery compartments 22, 24 extends longitudinally in the second extension direction 62, 64.

Thus, each of the first side battery compartments 21, 23 and each of the second side battery compartments 22, 24 may have one wall 21w, 23w, 22w, 24w which is the mantle of the non-circular cylinder.

Each of the first side battery compartments 21, 23 may extend longitudinally at least partially from the mounting block 10 to the outside of the mounting block 10.

Each of the second side battery compartments 22, 24 may extend longitudinally at least partially from the mounting block 10 to the outside of the mounting block 10.

Referring back to FIG. 2a, in an embodiment, the electrical engine mounting arrangement 1 comprises two motor shafts 42a, 42b, a first motor shaft 42a and a second motor shaft 42b, and two electric motors 40, 41, a first electric motor 40 and a second electric motor 41. The first electric motor 40 is arranged to rotate the first motor shaft 42a, and the second electric motor 41 is arranged to rotate the second motor shaft 42b. Two electric motors and two motor shafts increase safety and redundancy in the drive train system.

Referring still to FIG. 2a, in an embodiment, the electrical engine mounting arrangement 1 comprises two power transfer shafts 43, 43a, 43b, a first power transfer shaft 43a and a second power transfer shaft 43b. The first power transfer shaft 43a and the second power transfer shaft 43b are concentric. The first power transfer shaft 43a is arranged to rotate in response to the rotation of the first motor shaft 42a, and the second power transfer shaft 43b is arranged to rotate in response to the rotation of the second motor shaft 42b. A first propulsion element 15a is attached fixedly to the first power transfer shaft 43a, and a second propulsion element 15b is attached fixedly to the second power transfer shaft 43b. Two electric motors, two motor shafts, two power transfer shafts and two propulsion elements increase safety and redundancy in the drive train system further.

The first propulsion element 15a and the second propulsion element 15b may be arranged to rotate in opposite directions.

The first power transfer shaft 43a may arranged to rotate in response to the rotation of the first motor shaft 42a such that the first power transfer shaft 43a and the first motor shaft 42a are linked with a first belt, a first chain or first cogwheels or any combination thereof (not shown in FIG. 2a).

The second power transfer shaft 43b may arranged to rotate in response to the rotation of the second motor shaft 42b such that the second power transfer shaft 43b and the second motor shaft 42b are linked with a second belt, a second chain or second cogwheels or any combination thereof (not shown in FIG. 2a).

Referring back to FIG. 3a, in an embodiment, the electrical engine mounting arrangement 1 comprises two motor shafts 42a, 42b, a first motor shaft 42a and a second motor shaft 42b such that the first motor shaft 42a and the second motor shaft 42b are concentric and have a same axis of rotation. The electrical engine mounting arrangement 1 comprise also two electric motors, a first electric motor 40 and a second electric motor 41. The first electric motor 40 is arranged to rotate the first motor shaft 42a, and the second electric motor 41 is arranged to rotate the second motor shaft 42b.

Referring still to FIG. 3a, in an embodiment, the electrical engine mounting arrangement 1 comprises two motor shafts 42a, 42b, a first motor shaft 42a and a second motor shaft 42b such that the first motor shaft 42a and the second motor shaft 42b are concentric and have a same axis of rotation. The electrical engine mounting arrangement 1 comprises also two electric motors, a first electric motor 40 at the first mounting block end 3 of the mounting block 10 and a second electric motor 41 at the second mounting block end 4 of the mounting block 10. The first electric motor 40 is arranged to rotate the first motor shaft 42a, and the second electric motor 41 is arranged to rotate the second motor shaft 42b.

Referring to FIG. 3b, in an embodiment, the electrical engine mounting arrangement 1 comprises two motor shafts 42a, 42b, a first motor shaft 42a and a second motor shaft 42b such that the first motor shaft 42a and the second motor shaft 42b are concentric and have a same axis of rotation. The electrical engine mounting arrangement 1 comprises also two electric motors 40, 41, a first electric motor 40 and a second electric motor 41. The first electric motor 40 and the second electric motor 41 are arranged successively along the first motor shaft 42a and the second motor shaft 42b. The first electric motor 40 is arranged to rotate the first motor shaft 42a, and the second electric motor 41 is arranged to rotate the second motor shaft 42b.

The first electric motor 40 and the second electric motor 41 may be arranged successively along the first motor shaft 42a and the second motor shaft 42b at the first mounting block end 3.

The first electric motor 40 and the second electric motor 41 may be arranged successively along the first motor shaft 42a and the second motor shaft 42b at the second mounting block end 4.

Referring back to FIG. 3b, in an embodiment, the electrical engine mounting arrangement comprises two power transfer shafts 43, 43a, 43b, a first power transfer shaft 43a and a second power transfer shaft 43b. The first power transfer shaft 43a is attached to the first motor shaft 42a in the direction of the first motor shaft 42a such that the first power transfer shaft 43a and the first motor shaft 42a are concentric. The second power transfer shaft 43b is attached to the second motor shaft 42b in the direction of the second motor shaft 42b such that the second power transfer shaft 43b and the second motor shaft 42b are concentric. The electrical engine mounting arrangement 1 comprises a first propulsion element 15a attached fixedly to the first power transfer shaft 43a, and a second propulsion element 15b attached fixedly to the second power transfer shaft 43b.

Referring still to FIG. 3b, in an embodiment, the electrical engine mounting arrangement 1 comprises two power transfer shafts 43, 43a, 43b, a first power transfer shaft 43a and a second power transfer shaft 43b. The first power transfer shaft 43a is attached to the first motor shaft 42a in the direction of the first motor shaft 42a such that the first power transfer shaft 43a and the first motor shaft 42a are concentric. The second power transfer shaft 43b is attached to the second motor shaft 42b in the direction of the second motor shaft 42b such that the second power transfer shaft 43b and the second motor shaft 42b are concentric. The electrical engine mounting arrangement 1 comprises a first propulsion element 15a attached fixedly to the first power transfer shaft 43a, and a second propulsion element 15b attached fixedly to the second power transfer shaft 43b such that the first propulsion element 15a and the second propulsion element 15b are arranged to rotate in opposite directions.

The first motor shaft 42a and the first power transfer shaft 43a may be two parts of a first straight drivetrain shaft.

Thus, the first motor shaft 42a and the first power transfer shaft 43a may form a first straight drivetrain shaft.

The second motor shaft 42b and the second power transfer shaft 43b may be two parts of a second straight drivetrain shaft.

Thus, the second motor shaft 42b and the second power transfer shaft 43b may form a second straight drivetrain shaft.

The first power transfer shaft 43a may be attached to the first motor shaft 42a directly, in the direction of the first motor shaft 42a.

The first power transfer shaft 43a may be arranged to continue the first motor shaft 42a directly, in the direction of the first motor shaft 42a.

The second power transfer shaft 43b may be attached to the second motor shaft 42b directly, in the direction of the second motor shaft 42a.

The second power transfer shaft 43b may be arranged to continue the second motor shaft 42b directly, in the direction of the second motor shaft 42b.

The first straight drivetrain shaft may be hollow so that it may accommodate at least part of the second straight drivetrain shaft.

The second straight drivetrain shaft may be hollow so that it may accommodate at least part of the first straight drivetrain shaft.

The first motor shaft 42a may be hollow such that the first motor shaft 42a may accommodate part of the second motor shaft 42b.

The second motor shaft 42b may be hollow such that the second motor shaft 42b may accommodate part of the first motor shaft 42a.

The first power transfer shaft 43a may be hollow such that the first power transfer shaft 43a may accommodate part of the second power transfer shaft 43b.

The second power transfer shaft 43b may be hollow such that the second power transfer shaft 43b may accommodate part of the first power transfer shaft 43a.

The first power transfer shaft 43a and the second power transfer shaft 43b may be concentric.

The first propulsion element 15a and the second propulsion element 15b may be arranged at the first mounting block end 3.

The first propulsion element 15a and the second propulsion element 15b may be arranged at the second mounting block end 4.

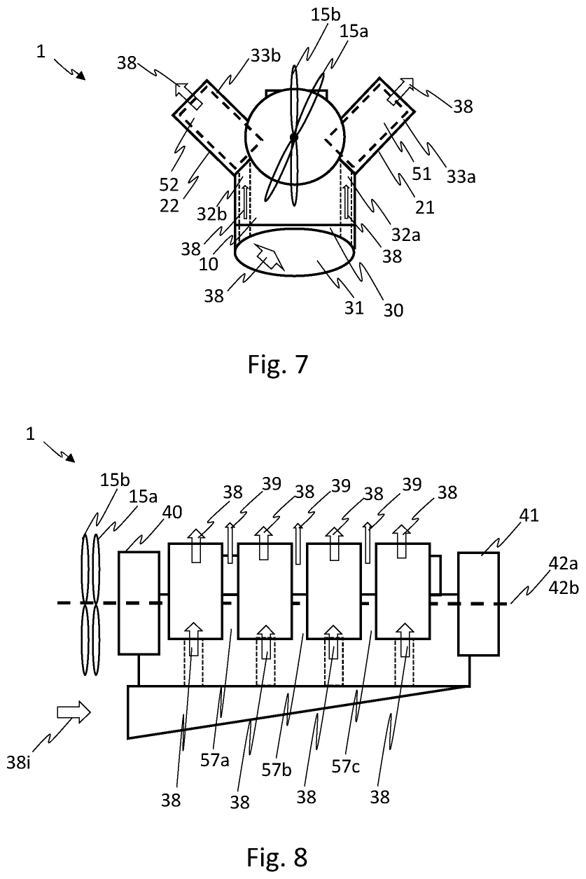

Referring next to FIGS. 7 and 8, in an embodiment, the electrical engine mounting arrangement 1 comprises a cooling air duct 30, a first side interposed volume 33a between the first side battery compartment 21, 23 and the at least one first side battery 51, 53, a second side interposed volume 33b between the second side battery compartment 22, 24 and the at least one second side battery 52, 54, a first flow connection 32a between the cooling air duct 30 and the first side interposed volume 33a, and a second flow connection 32b between the cooling air duct 30 and the second side interposed volume 33b.

The cooling air duct 30 comprises an air intake 31. The cooling air duct 30 is arranged to take in cooling air 38 from an airflow 38i in the vicinity of the electrical engine mounting arrangement 1 through the air intake 31, and feed the cooling air 38 to the first side interposed volume 33a through the first flow connection 32a, and to the second side interposed volume 33b through the second flow connection 32b.

The first flow connection 32a may be e.g. a tubing, a flow channel, a duct, or a drill hole, or any combination thereof.

The second flow connection 32b may be e.g. a tubing, a flow channel, a duct, or a drill hole, or any combination thereof.

The first side battery compartment 21, 23 may also comprise one or more holes arranged to vent out the cooling air 38 from the first side interposed volume 33a.

The second side battery compartment 22, 24 may also comprise one or more holes arranged to vent out the cooling air 38 from the second side interposed volume 33b.

The first side gaps 57a, 57b, 57c are advantageous, as they provide passive cooling for the first side battery compartments 21, 23 especially when the electrical engine mounting arrangement 1 is not moving. The first side gaps 57a, 57b, 57c provide a channel for a gap air flow 39 that cool the first side battery compartments 51, 53.

Referring also back to FIG. 1b in addition to FIG. 8, the second side gaps 58a, 58b, 58c are advantageous, as they provide passive cooling for the second side battery compartments 22, 24 especially when the electrical engine mounting arrangement 1 is not moving. The second side gaps 58a, 58b, 58c provide a channel for a gap air flow (not shown as hidden behind the structure) that cool the second side battery compartments 52, 54.

Referring back to FIG. 6a and FIG. 6b, in an embodiment, the electrical engine mounting arrangement 1 comprises a normal plane 73 having the rotation axis 60 as a normal direction. A first projection 61p, 63p of each of the first extension directions 61, 63 on the normal plane 73 has an intersection angle α, labelled 71, between a second projection 62p, 64p of each of the second extension directions 62, 64 on the normal plane 73, such that
the intersection angle α, shown with label 71, is between 30°-130°; or
the intersection angle α 71 is between 60°-120°; or
the intersection angle α 71 is between 80°-100°.

Referring to FIGS. 6d and 6e, in an embodiment, the electrical engine mounting arrangement 1 comprises a normal plane 73 having the rotation axis 60 as a normal direction. A first projection 61p, 63p of each of the first extension directions 61, 63 on the normal plane 73 has an intersection angle α, labelled 71, between a second projection 62p, 64p of each of the second extension directions 62, 64 on the normal plane 73, such that:
the intersection angle α71 is between 230°-330°; or
the intersection angle α71 is between 240°-300°; or
the intersection angle α71 is between 260°-280°.

Referring back to FIGS. 6a, 6b and 6c, in an embodiment of the electrical engine mounting arrangement 1, and as shown in FIG. 6a, when viewed in the direction of the rotation axis 60, the first side battery compartment 21, 23 and the second side battery compartment 22, 24 form together with the mounting block 10 a V-shaped shape.

The first side battery compartment 21, 23 and the second side battery compartment 22, 24 may form together with the mounting block 10 a V-shaped shape such that the V-shaped shape points in the direction of gravity when the vehicle 90V, 90AV is at rest.

Referring still to FIG. 6d and also to FIG. 6e, in an embodiment of the electrical engine mounting arrangement 1, when viewed in the direction of the rotation axis 60, the first side battery compartment 21, 23 and the second side battery compartment 22, 24 form together with the mounting block 10 an upside down V-shaped shape.

The first side battery compartment 21, 23 and the second side battery compartment 22, 24 may form together with the mounting block 10 an upside down V-shaped shape such that the upside down V-shaped shape points in the opposite direction of the direction of gravity when the vehicle 90V, 90AV is at rest.

The upside down V-shaped shape forms a Greek capital lambda (A) shaped shape.

The first side battery compartment 21, 23 and the second side battery compartment 22, 24 may form together with the mounting block 10 a Greek capital lambda (A) shaped shape such that the Greek capital lambda (A) shaped shape points in the opposite direction of the direction of gravity when the vehicle 90V, 90AV is at rest.

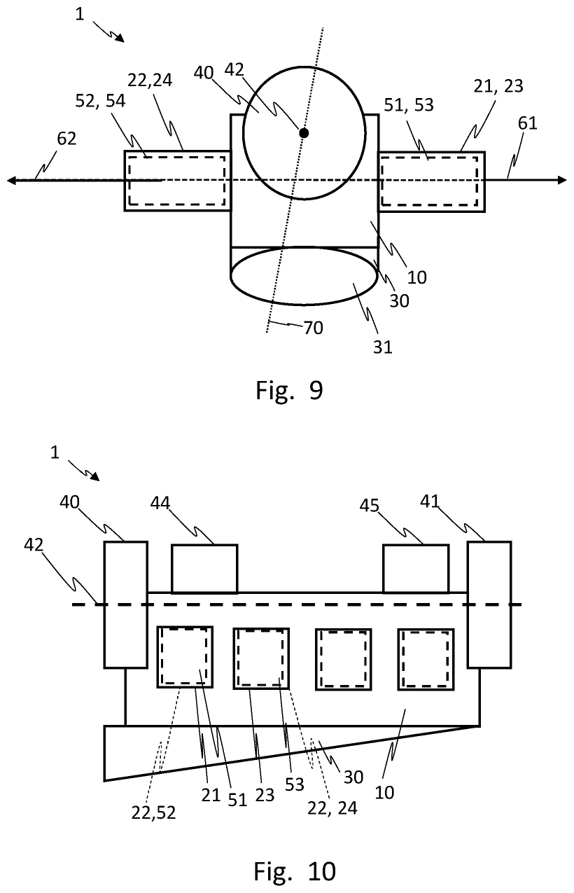

Referring next to FIGS. 9 and 10, in an embodiment, the first extension direction 61, 63 of each of the first side battery compartments 21, 23 and the second extension direction 62, 64 of each of the second side battery compartments 22, 24 have opposite directions. Second side battery compartments 22 and 24 are behind the structure, as are second side batteries 52, 54.

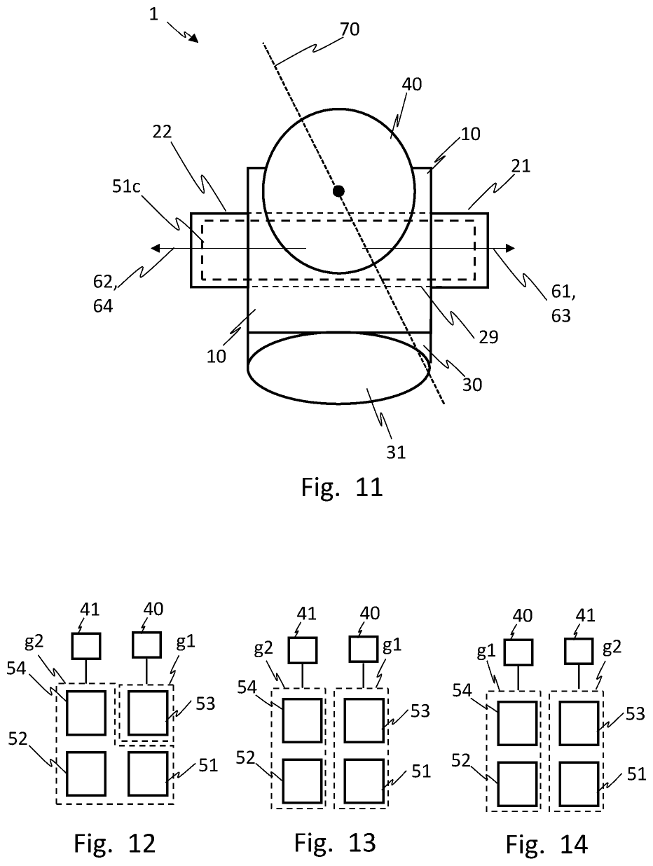

Referring next to FIG. 11, in an embodiment, the first extension direction 61, 63 of each of the first side battery compartments 21, 23 and the second extension direction 62, 64 of each of the second side battery compartments 22, 24 have opposite directions. Further, each of the first side battery compartments 21, 23 and each of the second side battery compartments 22, 24 are arranged to house a combined battery unit 51c. The combined battery unit 51c comprises the at least one first side battery 51, 53 and the at least one second side battery 52, 54.

Referring back to FIGS. 9 and 10, in an embodiment of the electrical engine mounting arrangement 1, each of the first side battery compartments 21, 23 has an opposing second side battery compartment 22, 24 at the other side of the division plane 70, the opposing second side battery compartment 22, 24 being one of the second side battery compartments 22, 24.

Referring back to FIG. 11, in an embodiment of the electrical engine mounting arrangement 1, each of the first side battery compartments 21, 23 has an opposing second side battery compartment 22, 24 at the other side of the division plane 70, the opposing second side battery compartment 22, 24 being one of the second side battery compartments 22, 24. Further, each of the first side battery compartments 21, 23 and each of the opposing second side battery compartments 22, 24 are arranged to house a combined battery unit 51c. The combined battery unit 51c comprises at least one first side battery 51, 53 and at least one second side battery 52, 54.

Referring to FIG. 12, in an embodiment of the electrical engine mounting arrangement 1, each of the first side batteries 51, 53 and each of the second side batteries 52, 54 belong either to a first battery group g1 or to a second battery group g2, and the first battery group g1 is arranged to supply energy to the first electric motor 40, and the second battery group g2 is arranged to supply energy to the second electric motor 41.

Referring to FIG. 13, in an embodiment of the electrical engine mounting arrangement 1, each of the first side batteries 51, 53 belong to a first battery group g1, and each of the second side batteries 52, 54 belong to a second battery group g2. The first battery group g1 is arranged to supply energy to the first electric motor 40, and the second battery group g2 is arranged to supply energy to the second electric motor 41.

Referring to FIG. 14, in an embodiment of the electrical engine mounting arrangement 1, each of the first side batteries 51, 53 belong to a second battery group g2, and each of the second side batteries 52, 54 belong to a first battery group g1. The first battery group g1 is arranged to supply energy to the first electric motor 40, and the second battery group g2 is arranged to supply energy to the second electric motor 41.

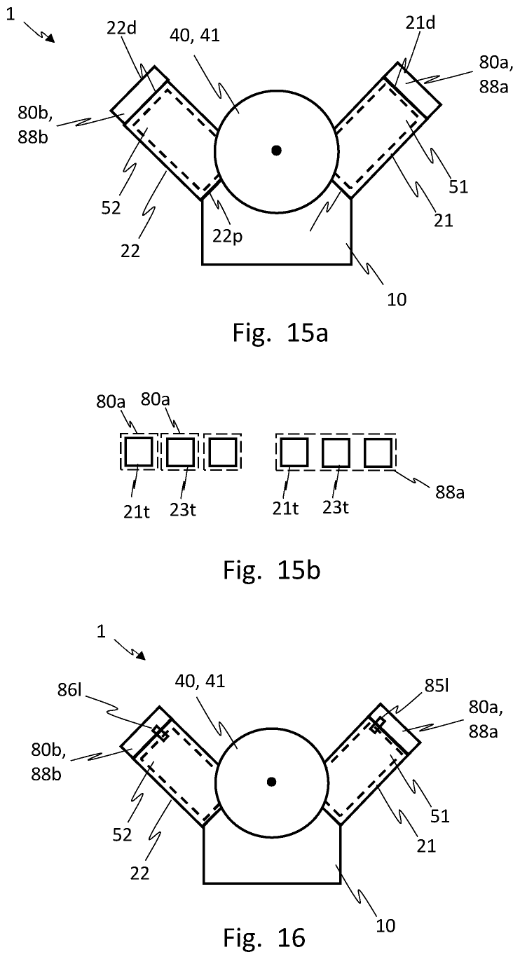

Referring to FIG. 15a and FIG. 15b, in an embodiment of the electrical engine mounting arrangement 1, each of the first side battery compartments 21, 23 comprises a first side lid 80a at the first side battery compartment top 21t, 23t of each of the first side battery compartments 21, 23. Each of the first side battery compartment tops 21t, 23t is arranged to be closed with the first side lid 80a. Further, each of the second side battery compartments 22, 24 comprises a second side lid 80b at the second side battery compartment top 22t, 24t of each of the second side battery compartments 22, 24. Each of the second side battery compartment tops 22t, 24t is arranged to be closed with the second side lid 80b.

In other words, each of the first side battery compartments 21, 23 may have a separate first side lid 80a.

In other words, each of the second side battery compartments 22, 24 may have a separate second side lid 80b.

Each of the first side lids 80a may be connected to the first side battery compartment 21, 23 with a hinge (not shown).

Each of the first side lids 80a may be locked to a closed position with a lock (not shown).

Each of the second side lids 80b may be connected to the second side battery compartment 22, 24 with a hinge (not shown).

Each of the second side lids 80b may be locked to a closed position with a lock (not shown).

FIG. 15b shows only the first side lids 80a and the first side battery compartment tops 21t, 23t.

Referring to FIG. 15a and FIG. 15b, in an embodiment of the electrical engine mounting arrangement 1, the electrical engine mounting arrangement 1 comprises a first side combination lid 88a, and each of the first side battery compartment tops 21t, 23t is arranged to be closed with the first side combination lid 88a. Further, the electrical engine mounting arrangement 1 comprises a second side combination lid 88b, and each of the second side battery compartment tops 24t, 22t is arranged to be closed with the second side combination lid 88b.

Again, FIG. 15b shows only first side combination lid 88a and first side battery compartment tops 21t, 23t.

The first side combination lid 88a may be connected to at least one of the first side battery compartments 21, 23 with a hinge (not shown).

The second side combination lid 88b may be connected to at least one of the second side battery compartments 22, 24 with a hinge (not shown).

Referring to FIG. 16, in an embodiment of the electrical engine mounting arrangement 1, each of the first side batteries 51, 53 is arranged to supply energy to the electric motor 40, 41 through a first side electrical lid connector 851 arranged at the first side combination lid 88a, and each of the second side batteries 52, 54 is arranged to supply energy to the electric motor 40, 41 through a second side electrical lid connector 861 arranged at the second side combination lid 88b.

Referring to FIG. 16, in an embodiment of the electrical engine mounting arrangement 1, each of the first side batteries 51, 53 is arranged to supply energy to the electric motor 40, 41 through a first side electrical lid connector 851 arranged at the first side lid 80a. Each of the second side batteries 52, 54 is arranged to supply energy to the electric motor 40, 41 through a second side electrical lid connector 861 arranged at the second side lid 80b.

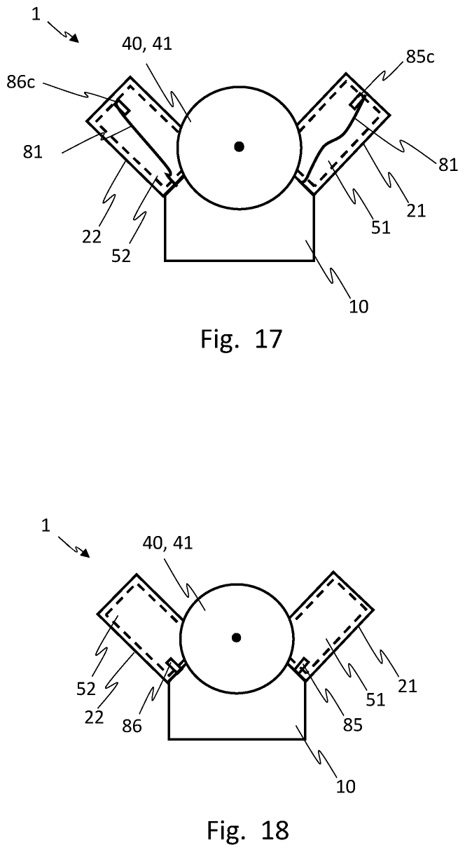

Referring to FIG. 17, in an embodiment of the electrical engine mounting arrangement 1, each of the first side batteries 51, 53 is arranged to supply energy to the electric motor 40, 41 through cables 81 electrically connected to the first side battery 51, 53 with a first side battery connector 85c, and each of the second side batteries 52, 54 is arranged to supply energy to the electric motor 40, 41 through cables 81 electrically connected to the second side battery 52, 54 with a second side battery connector 86c.

Referring next to FIG. 18, in an embodiment of the electrical engine mounting arrangement 1, each of the first side battery compartments 21, 23 comprises a first side electrical bottom connector 85 arranged at the first side battery compartment bottom 21b, 23b of the first side battery compartment 21, 23. The at least one first side battery 51, 53 is arranged to supply energy to the electric motor 40, 41 through a first side electrical bottom connector 85. Further, each of the second side battery compartments 22, 24 comprises a second side electrical bottom connector 86 arranged at the second side battery compartment bottom 22b, 24b of the second side battery compartment 22, 24. The at least one second side battery 52, 54 is arranged to supply energy to the electric motor 40, 41 through a second side electrical bottom connector 86.

The invention has been described above with reference to the examples shown in the figures. However, the invention is in no way restricted to the above examples but may vary within the scope of the claims.

1.-24. (canceled)

25. An electrical engine mounting arrangement for providing propulsion power to a vehicle, wherein the electrical engine mounting arrangement comprises:
A) a mounting block,
B) an electric motor fixedly attached to the mounting block,
C1) a motor shaft, the electric motor arranged to rotate the motor shaft,
C2) a power transfer shaft, the power transfer shaft arranged to rotate in response to the rotation of the motor shaft, the power transfer shaft aligned along a rotation axis such that the rotation axis lies on a division plane, the division plane arranged to split the electrical engine mounting arrangement into two portions, a first portion at a first side of the division plane, and a second portion at a second side of the division plane,
D) one or more first side battery compartments fixedly attached to the mounting block at the first side of the division plane, each of the first side battery compartments comprising:
a first side battery compartment top,
a first side battery compartment bottom, and
one or more first side battery compartment walls between the first side battery compartment top and the first side battery compartment bottom,
the first side battery compartment top, the first side battery compartment bottom and the one or more first side battery compartment walls defining a first inner volume of the first side battery compartment, the first inner volume of the first side battery compartment arranged to house at least part of at least one first side battery such that the at least one first side battery is detachable, the at least one first side battery arranged to supply energy to the electric motor for rotating the motor shaft; and
E) one or more second side battery compartments fixedly attached to the mounting block at the second side of the division plane, each of the second side battery compartments comprising:
a second side battery compartment top,
a second side battery compartment bottom, and
one or more second side battery compartment walls between the second side battery compartment top and the second side battery compartment bottom,
the second side battery compartment top, the second side battery compartment bottom and the one or more second side battery compartment walls defining a second inner volume of the second side battery compartment, the second inner volume of the second side battery compartment arranged to house at least part of at least one second side battery such that the at least one second side battery is detachable, the at least one second side battery arranged to supply energy to the electric motor for rotating the motor shaft.

26. The electrical engine mounting arrangement according to claim 25, wherein the mounting block comprises:
a first mounting block end and a second mounting block end opposite the first mounting block end; or
a first mounting block end and a second mounting block end opposite the first mounting block end, and
the electrical engine mounting arrangement is arranged to be attached to the vehicle at the second mounting block end.

27. The electrical engine mounting arrangement according to claim 26, wherein:
the mounting block comprises an I-beam extending between the first mounting block end and the second mounting block end; or
the mounting block comprises an I-beam extending between the first mounting block end and the second mounting block end,
the I-beam comprises a top flange, a bottom flange and a web, and
the one or more first side battery compartments are fixedly attached to the top flange, to the bottom flange and to the web, and
the one or more second side battery compartments are fixedly attached to the top flange, to the bottom flange and to the web.

28. The electrical engine mounting arrangement according to claim 26 wherein:
the mounting block comprises a triangular cross section beam extending between the first mounting block end and the second mounting block end; or
the mounting block comprises a triangular cross section beam extending between the first mounting block end and the second mounting block end,
the triangular cross section beam comprises a top section split by the division plane, a first side section at the first side of the division plane, and a second side section at the second side of the division plane,
the one or more first side battery compartments are fixedly attached to the first side section, and
the one or more second side battery compartments are fixedly attached to the second side section.

29. The electrical engine mounting arrangement according to claim 25, wherein:
the electrical engine mounting arrangement is attached fixedly to a tubing frame, the tubing frame comprising interjoined tubing sections, and
the electrical engine mounting arrangement is attached to the vehicle with the tubing frame.

30. The electrical engine mounting arrangement according to claim 25, wherein the electrical engine mounting arrangement comprises:
more than one first side battery compartments, each of the first side battery compartments separated from an adjacent first side battery compartment with a first side gap, and
more than one second side battery compartments, each of the second side battery compartments separated from an adjacent second side battery compartment with a second side gap.

31. The electrical engine mounting arrangement according to claim 25, wherein:
the electrical engine mounting arrangement comprises a propulsion element, the propulsion element arranged to provide propulsion to the vehicle in response to the rotation of the power transfer shaft, the electrical engine mounting arrangement being fixedly attached to the vehicle; or
the electrical engine mounting arrangement comprises a propulsion element attached to the power transfer shaft, the propulsion element arranged to provide propulsion to the vehicle in the direction of the power transfer shaft, the electrical engine mounting arrangement being fixedly attached to the vehicle; or
the electrical engine mounting arrangement comprises a propulsion element attached to the power transfer shaft, the propulsion element arranged to provide propulsion to an aircraft in the direction of the power transfer shaft, the electrical engine mounting arrangement being fixedly attached to a nose of the aircraft; or
the electrical engine mounting arrangement comprises a propulsion element attached to the power transfer shaft, the propulsion element arranged to provide propulsion to an aircraft in the direction of the power transfer shaft, the electrical engine mounting arrangement being fixedly attached to a wing of the aircraft; or
the electrical engine mounting arrangement comprises a propulsion element attached to the power transfer shaft, the propulsion element arranged to provide propulsion to an aircraft in the direction of the power transfer shaft, the electrical engine mounting arrangement being fixedly attached to a nose of the aircraft such that when the aircraft rests on a horizontal ground, the division plane is perpendicular to the horizontal ground.

32. The electrical engine mounting arrangement according to claim 25, wherein:
each of the first side battery compartments has a first extension direction, and each of the first side battery compartments extends longitudinally along the first extension direction between the first side battery compartment bottom and the first side battery compartment top, and
each of the second side battery compartments has a second extension direction, and each of the second side battery compartments extends longitudinally along the second extension direction between the second side battery compartment bottom and the second side battery compartment top.

33. The electrical engine mounting arrangement according to claim 32, wherein:
each of the first side battery compartments has a shape of a longitudinal and rectangular parallelepiped extending to the outside of the mounting block, each of the first side battery compartments extending longitudinally in the first extension direction, and
each of the second side battery compartments has a shape of a longitudinal and rectangular parallelepiped extending to the outside of the mounting block, each of the second side battery compartments extending longitudinally in the second extension direction; or
each of the first side battery compartments has a shape of a longitudinal circular cylinder extending to the outside of the mounting block, each of the first side battery compartments extending longitudinally in the first extension direction, and
each of the second side battery compartments has a shape of a longitudinal circular cylinder extending to the outside of the mounting block, each of the second side battery compartments extending longitudinally in the second extension direction; or
each of the first side battery compartments has a shape of a longitudinal non-circular cylinder extending to the outside of the mounting block, each of the first side battery compartments extending longitudinally in the first extension direction, and
each of the second side battery compartments has a shape of a longitudinal non-circular cylinder extending to the outside of the mounting block, each of the second side battery compartments extending longitudinally in the second extension direction.

34. The electrical engine mounting arrangement according to claim 25, wherein the electrical engine mounting arrangement comprises:
two motor shafts, a first motor shaft and a second motor shaft,
two electric motors, a first electric motor and a second electric motor,
the first electric motor arranged to rotate the first motor shaft, and the second electric motor arranged to rotate the second motor shaft.

35. The electrical engine mounting arrangement according to claim 34, wherein the electrical engine mounting arrangement comprises:
two power transfer shafts, a first power transfer shaft and a second power transfer shaft, the first power transfer shaft and the second power transfer shaft being concentric,
the first power transfer shaft being arranged to rotate in response to the rotation of the first motor shaft, and the second power transfer shaft being arranged to rotate in response to the rotation of the second motor shaft, and
a first propulsion element attached fixedly to the first power transfer shaft, and a second propulsion element attached fixedly to the second power transfer shaft.

36. The electrical engine mounting arrangement according to claim 26, wherein the electrical engine mounting arrangement comprises:
two motor shafts, a first motor shaft and a second motor shaft such that the first motor shaft and the second motor shaft are concentric and have a same axis of rotation, and two electric motors, a first electric motor and a second electric motor,
the first electric motor arranged to rotate the first motor shaft, and the second electric motor arranged to rotate the second motor shaft; or
two motor shafts, a first motor shaft and a second motor shaft such that the first motor shaft and the second motor shaft are concentric and have a same axis of rotation, and
two electric motors, a first electric motor and a second electric motor, the first electric motor and the second electric motor arranged successively along the first motor shaft and the second motor shaft,
the first electric motor arranged to rotate the first motor shaft, and the second electric motor arranged to rotate the second motor shaft; or
two motor shafts, a first motor shaft and a second motor shaft such that the first motor shaft and the second motor shaft are concentric and have a same axis of rotation, and
two electric motors, a first electric motor at the first mounting block end of the mounting block and a second electric motor at the second mounting block end of the mounting block,
the first electric motor being arranged to rotate the first motor shaft, and the second electric motor being arranged to rotate the second motor shaft.

37. The electrical engine mounting arrangement according to claim 36, wherein:
the electrical engine mounting arrangement comprises two power transfer shafts, a first power transfer shaft and a second power transfer shaft,
the first power transfer shaft is attached to the first motor shaft in the direction of the first motor shaft such that the first power transfer shaft and the first motor shaft are concentric,
the second power transfer shaft is attached to the second motor shaft in the direction of the second motor shaft such that the second power transfer shaft and the second motor shaft are concentric, and
the electrical engine mounting arrangement comprises a first propulsion element attached fixedly to the first power transfer shaft, and a second propulsion element attached fixedly to the second power transfer shaft; or
the electrical engine mounting arrangement comprises two power transfer shafts, a first power transfer shaft and a second power transfer shaft,
the first power transfer shaft is attached to the first motor shaft in the direction of the first motor shaft such that the first power transfer shaft and the first motor shaft are concentric, the second power transfer shaft is attached to the second motor shaft in the direction of the second motor shaft such that the second power transfer shaft and the second motor shaft are concentric, and
the electrical engine mounting arrangement comprises a first propulsion element attached fixedly to the first power transfer shaft, and a second propulsion element attached fixedly to the second power transfer shaft such that the first propulsion element and the second propulsion element are arranged to rotate in opposite directions.

38. The electrical engine mounting arrangement according to claim 25, wherein the electrical engine mounting arrangement comprises:
a cooling air duct,
a first side interposed volume between the first side battery compartment and the at least one first side battery,
a second side interposed volume between the second side battery compartment and the at least one second side battery,
a first flow connection between the cooling air duct and the first side interposed volume,
a second flow connection between the cooling air duct and the second side interposed volume
the cooling air duct comprising an air intake, the cooling air duct arranged to:
take in cooling air from an airflow in the vicinity of the electrical engine mounting arrangement through the air intake, and
feed the cooling air to the first side interposed volume through the first flow connection, and to the second side interposed volume through the second flow connection.

39. The electrical engine mounting arrangement according to claim 32, wherein:
the electrical engine mounting arrangement comprises a normal plane having the rotation axis as a normal direction,
a first projection of each of the first extension directions on the normal plane has an intersection angle α between a second projection of each of the second extension directions on the normal plane, such that:
the intersection angle α is between 30°-130°; or
the intersection angle α is between 60°-120°; or
the intersection angle α is between 80°-100°; or
the intersection angle α is between 230°-330°; or
the intersection angle α is between 240°-300°; or
the intersection angle α is between 260°-280°.

40. The electrical engine mounting arrangement according to claim 25, wherein when viewed in the direction of the rotation axis, the first side battery compartment and the second side battery compartment form together with the mounting block:
a V-shaped shape; or
an upside down V-shaped shape.

41. The electrical engine mounting arrangement according to claim 32, wherein:
the first extension direction of each of the first side battery compartments and the second extension direction of each of the second side battery compartments have opposite directions; or
the first extension direction of each of the first side battery compartments and the second extension direction of each of the second side battery compartments have opposite directions, and
each of the first side battery compartments and each of the second side battery compartments are arranged to house a combined battery unit, the combined battery unit comprising the at least one first side battery and the at least one second side battery.

42. The electrical engine mounting arrangement according to claim 25, wherein:
each of the first side battery compartments has an opposing second side battery compartment at the other side of the division plane, the opposing second side battery compartment being one of the second side battery compartments; or
each of the first side battery compartments has an opposing second side battery compartment at the other side of the division plane, the opposing second side battery compartment being one of the second side battery compartments, and
each of the first side battery compartments and each of the opposing second side battery compartments are arranged to house a combined battery unit, the combined battery unit comprising at least one first side battery and at least one second side battery.

43. The electrical engine mounting arrangement according to claim 34, wherein:
each of the first side batteries and each of the second side batteries belong either to a first battery group (g1) or to a second battery group (g2),
the first battery group (g1) is arranged to supply energy to the first electric motor, and the second battery group (g2) is arranged to supply energy to the second electric motor; or
each of the first side batteries belong to a first battery group (g1),
each of the second side batteries belong to a second battery group (g2),
the first battery group (g1) is arranged to supply energy to the first electric motor, and the second battery group (g2) is arranged to supply energy to the second electric motor; or
each of the first side batteries belong to a second battery group (g2),
each of the second side batteries belong to a first battery group (g1),
the first battery group (g1) is arranged to supply energy to the first electric motor, and the second battery group (g2) is arranged to supply energy to the second electric motor.

44. The electrical engine mounting arrangement according to claim 25, wherein:
each of the first side battery compartments comprises a first side lid at the first side battery compartment top of each of the first side battery compartments,
each of the first side battery compartment tops is arranged to be closed with the first side lid,
each of the second side battery compartments comprises a second side lid at the second side battery compartment top of each of the second side battery compartments, and
each of the second side battery compartment tops is arranged to be closed with the second side lid.
